(19) United States
(12) Patent Application Publication
(10) Pub. No.: US 2009/0103958 A1
(43) Pub. Date: Apr. 23, 2009

(54) INDUCTION HEATING FIXING DEVICE FOR IMAGE FORMING APPARATUS

(75) Inventors: Masanori TAKAI, Shizuoka (JP); Shuji YOKOYAMA, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/247,133

(22) Filed: Oct. 7, 2008

Related U.S. Application Data
(60) Provisional application No. 60/981,791, filed on Oct. 22, 2007.

(51) Int. Cl. G03G 15/20; H05B 6/10

(52) U.S. Cl. 399/330; 219/619

(57) ABSTRACT

In an embodiment of the present invention, one side of first and second side coils formed by winding a Litz wire plural times are formed by bending the Litz wire and the other sides thereof are formed by simply winding the Litz wire without bending the same. The bent one ends of the first and second side coils are arranged to be adjacent to a center coil and the other ends simply wound without being bent are arranged to be opposed to both ends of a heat roller.

### CROSS-REFERENCE TO RELATED APPLICATION

This application is based upon and claims the benefit of priority from U.S. Provisional Application Ser. No. 60/981,791 filed on Oct. 22, 2007, the entire contents of which are incorporated herein by reference.

### TECHNICAL FIELD

The present invention relates generally to an induction heating fixing device mounted on an image forming apparatus such as a copying machine, a printer, or a facsimile, and, more particularly to an induction heating fixing device for an image forming apparatus that has a conductive heat generating member heated by induction heating and fixes a toner image on an image fixing medium using the conductive heat generating member.

### BACKGROUND

As a fixing device of a heating and pressing type used in image forming apparatuses such as a copying machine and a printer of an electrophotographic system, there is an induction heating fixing device that heats a heat roller, a heating belt, or the like in an induction heating system. This induction heating fixing device has high responsiveness to a temperature change in the heat roller or the like. Therefore, the induction heating fixing device can immediately raise the temperature of the heat roller or the like and can realize an increase in process speed including a reduction in warming-up time. The induction heating system is a system for feeding a high-frequency current to an induction current generating coil to generate an electromagnetic wave, feeding an induction current generated by the electromagnetic wave to, for example, a metal conductive layer of a heat roller, and causing the metal conductive layer to generate heat with Joule heat generated by the induction current.

As one type of the induction heating fixing device of the induction heating system, for example, there is a device in which both ends of an induction current generating coil are bent or piled up. With the induction current generating coil bent or piled up at both the ends in this way, for example, when a heat roller is heated over the entire length in a longitudinal direction by using plural induction current generating coils, joints of the induction current generating coils adjacent to one another can be set in close contact with one another. Consequently, a temperature fall in the heat roller due to a fall in an electromagnetic wave in the joints of the induction current generating coils is prevented to realize uniformity of the temperature of the heat roller. Moreover, a reduction in size of the induction heating fixing device is realized by also using, at ends of the heat roller, the induction current generating coils bent or piled up at both the ends.

However, it takes time and labor to manufacture the induction current generating coil bent or piled up at both the ends in this way. In other words, after conductive wires are wound plural times, the conductive wires have to be bent and set to the same height or every time the conductive wires are wound, the conductive wires have to be piled up while being arranged to the same height at both ends thereof. Therefore, manufacturing cost for the induction current generating coil increases. Moreover, when both the ends of the induction current generating coil are bent, it is likely that a flow of wind for cooling the induction current generating coil to improve induction heating efficiency of the heat roller is disturbed and cooling efficiency of the induction current generating coil is deteriorated.

Therefore, there is a demand for an induction heating fixing device for an image forming apparatus that can obtain high induction heating efficiency with a lower-price induction current generating coil.

### SUMMARY

According to an aspect of the present invention, there is provided an induction heating device for an image forming apparatus that includes an induction current generating coil, which is easy to manufacture and realizes a reduction in price, and makes it possible to improve cooling efficiency of the induction current generating coil, is low in price, and has high induction heating efficiency.

According to an embodiment of the present invention, the induction heating device for an image forming apparatus includes a conductive heat generating member of an endless shape and a first induction current generating coil formed by winding a conductive wire plural times to generate an induction current in the conductive heat generating member. In the first induction current generating coil, at one end in a direction parallel to a rotating direction of the conductive heat generating member, the conductive wire is wound along the shape of the conductive heat generating member and, at the other end in the direction parallel to the rotating direction of the conductive heat generating member, the conductive wire is wound to overlap in a direction away from the conductive heat generating member.

### DESCRIPTION OF THE DRAWINGS

FIG. 1 is a schematic structural diagram showing an image forming apparatus mounted with a fixing device according to a first embodiment of the present invention;

FIG. 2 is a schematic structural diagram showing the fixing device according to the first embodiment of the present invention;

FIG. 3 is a schematic explanatory diagram showing an arrangement of a coil unit according to the first embodiment of the present invention;

FIG. 4 is a schematic explanatory diagram of the coil unit according to the first embodiment of the present invention viewed from an oblique direction;

FIG. 5 is a schematic explanatory diagram of the coil unit according to the first embodiment of the present invention from which a magnetic core in FIG. 4 is removed;

FIG. 6 is a schematic explanatory diagram showing an air flow around the coil unit according to the first embodiment of the present invention;

FIG. 7 is a schematic explanatory diagram showing an arrangement of a coil unit according to a second embodiment of the present invention;

FIG. 8 is a schematic explanatory diagram showing an air flow around the coil unit according to the second embodiment of the present invention; and

FIG. 9 is a schematic explanatory diagram showing a heat roller according to the second embodiment of the present invention and a temperature distribution around the heat roller.

### DETAILED DESCRIPTION

A first embodiment of the present invention is explained in detail below with reference to the accompanying drawings.

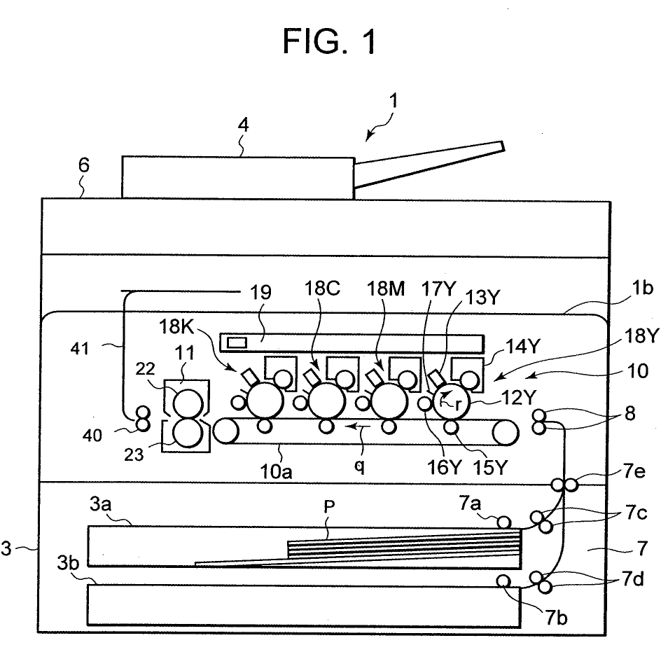

FIG. 1 is a schematic structural diagram showing a color copying machine 1 of a four-tandem system mounted with a fixing device 11, which is an induction heating fixing device, according to the first embodiment of the present invention. The color copying machine 1 includes, in an upper part thereof, a scanner unit 6 that scans an original supplied by an automatic document feeder 4. The color copying machine 1 includes an image forming unit 10 including four image forming stations 18Y, 18M, 18C, and 18K for yellow (Y), magenta (M), cyan (C), and black (K) arranged in parallel along a transfer belt 10a.

In the image forming station 18Y for yellow (Y), a charging device 13Y as a process member, a developing device 14Y, a transfer roller 15Y, a cleaner 16Y, and a charge removing device 17Y are arranged around a photoconductive drum 12Y as an image carrier that rotates in an arrow r direction. A laser exposing device 19 that irradiates a laser beam on the photoconductive drum 12Y is provided above the image forming station 18Y for yellow (Y).

The image forming stations 18M, 18C, and 18K for the respective colors of magenta (M), cyan (C), and black (K) have the same configuration as the image forming station 18Y for yellow (Y).

In the image forming unit 10, according to the start of print operation, in the image forming station 18Y for yellow (Y), the photoconductive drum 12Y rotates in the arrow r direction to be uniformly charged by the charging device 13Y. Subsequently, exposure light corresponding to image information scanned by the scanner unit 6 is irradiated on the photoconductive drum 12Y by the laser exposing device 19 and an electrostatic latent image is formed thereon. Thereafter, a toner image is formed on the photoconductive drum 12Y by the developing device 14Y. In the position of the transfer roller 15Y, the toner image is transferred onto sheet paper P, which is an image fixing medium, carried in an arrow q direction on the transfer belt 10a. After the transfer is finished, a residual toner on the photoconductive drum 12Y is cleaned from the photoconductive drum 12Y by the cleaner 16. Charges on the surface of the photoconductive drum 12Y are removed by the charge removing device 17Y. In this way, the photoconductive drum 12Y is prepared for the next print.

The sheet paper P is fed from a cassette mechanism 3 including first and second paper feeding cassettes 3a and 3b to the transfer belt 10a through a carrying path 7. The carrying path 7 includes pickup rollers 7a and 7b that take out the sheet paper from the paper feeding cassettes 3a and 3b, separating and carrying rollers 7c and 7d, carrying rollers 7e, and registration rollers 8. The fixing device 11 that fixes a toner image formed on the sheet paper P by the image forming unit 10 is provided downstream of the transfer belt 10a. Paper discharge rollers 40 and a paper discharging and carrying path 41 for carrying the sheet paper P after fixing to a paper discharge unit 1b are provided downstream of the fixing device 11.

The image forming stations 18M, 18C, and 18K for the respective colors of magenta (M), cyan (C), and black (K) perform image forming operation in the same manner as the image forming station 18Y for yellow (Y) and form a full color toner image on the sheet paper P carried by the transfer belt 10a. Thereafter, the sheet paper P is heated and pressed by the fixing device 11, which is the induction heating fixing device, to have the full color toner image fixed thereon. After a print image is completed, the sheet paper P is discharged to the paper discharge unit 1b.

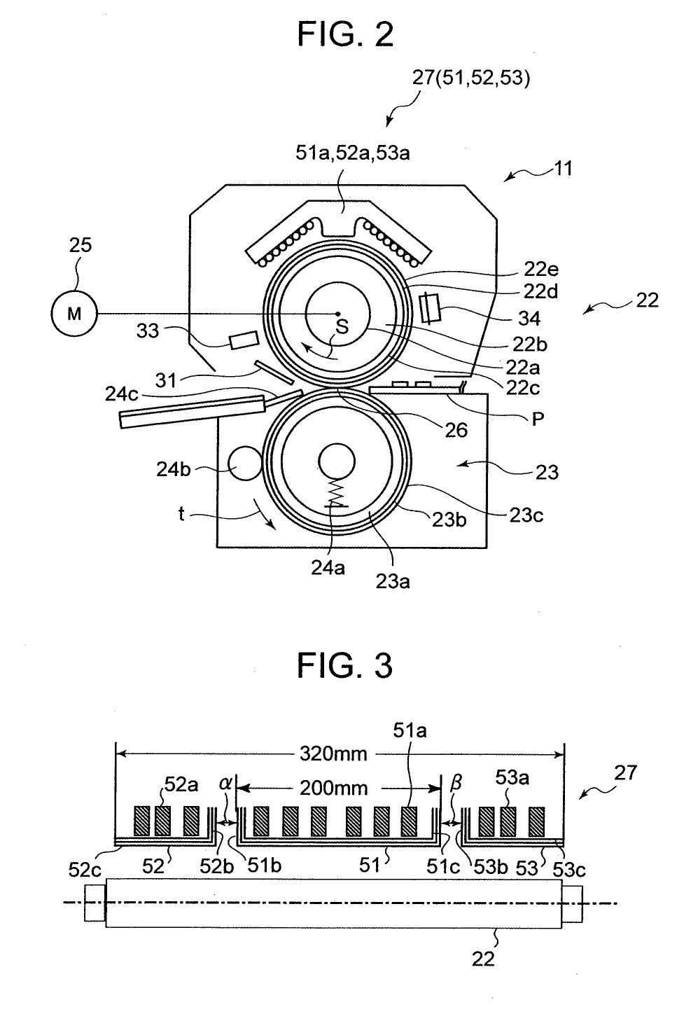

The fixing device 11 is described. FIG. 2 is a schematic structural diagram showing the fixing device 11 of the induction heating system. The fixing device 11 includes a heat roller 22 as a heating member and a press roller 23 as a carrying member. The heat roller 22 is rotated in an arrow s direction by a driving motor 25. The press roller 23 is pressed and brought into contact with the heat roller 22 by a pressing spring 24a. Consequently, a nip 26 with fixed width is formed between the heat roller 22 and the press roller 23. The press roller 23 rotates in an arrow t direction following the heat roller 22.

A coil unit 27 as an induction current generating coil that causes the heat roller 22 to generate heat is arranged to be opposed to the heat roller 22 via a gap of, for example, 2.5 mm. The gap between the coil unit 27 and the heat roller 22 is not limited. However, to satisfactorily cause the heat roller 22 to generate heat, it is preferable to set the gap in a range of 1.5 mm to 5.0 mm.

Moreover, in an outer periphery of the heat roller 22, a peeling pawl 31 that prevents twining of the sheet paper P after fixing, a non-contact thermistor 33 that detects the surface temperature of the heat roller 22, and a thermostat 34 for sensing abnormality of the surface temperature of the heat roller 22 and interrupting heat generation are provided. A press-side peeling pawl 24c and a cleaning roller 24b are provided in an outer circumference of the press roller 23.

When it is unlikely that the sheet paper P twines around the heat roller 22, the peeling pawl 31, the press-side peeling pawl 24c, and the like do not have to be provided. The number of non-contact thermistors 33 is arbitrary according to necessity. A necessary number of non-contact thermistors 33 can be arranged in necessary places in a longitudinal direction of the heat roller 22, which is a rotating shaft direction of the heat roller 22.

In the heat roller 22, around a shaft 22a formed of a material having rigidity (hardness) that is not deformed by predetermined pressure, an elastic layer 22b made of an elastic material such as foamed rubber or sponge, a metal conductive layer 22c made of a conductive material as a conductive heat generating member, a solid rubber layer 22d made of heat resistant silicone rubber or the like, and a release layer 22e are formed in order. The metal conductive layer 22c is formed of a conductive material made of nickel (Ni), stainless steel, aluminum (Al), copper (Cu), a composite material of stainless steel and aluminum, or the like. In this embodiment, the metal conductive layer 22c is formed of nickel (Ni).

It is preferable that, in the heat roller 22, for example, the elastic layer 22b is formed in the thickness of 5 mm to 10 mm, the metal conductive layer 22c is formed in the thickness of 10 μm to 100 μm, and the solid rubber layer 22d is formed in the thickness of 100 μm to 200 μm. In this embodiment, the elastic layer 22b is formed in the thickness of 5 mm, the metal conductive layer 22c is formed in the thickness of 40 μm, the solid rubber layer 22d is formed in the thickness of 200 μm, and the release layer 22e is formed in the thickness of 30 μm.

The press roller 23 includes a core bar 23a and a rubber layer 23b of silicone rubber, fluorine rubber, or the like around the core bar 23a. The rubber layer 23b is coated with a release layer 23c. Both the heat roller 22 and the press roller 23 are formed with a diameter of, for example, 40 mm. The sheet paper P passes through the nip 26 between the heat roller 22 and the press roller 23, whereby the toner image on the sheet paper P is heated, pressed, and fixed thereon.

The press roller 23 has, when necessary, a metal conductive layer that is caused to generate heat by the electromagnetic induction coil or may have a heating mechanism such as a halogen lamp heater incorporated therein.

The coil unit 27 is described. The coil unit 27 includes a center coil 51 and first and second side coils 52 and 53. The first and second side coils 52 and 53 are formed in an identical shape. Magnetic cores 51a, 52a, and 53a of the respective coils 51, 52, and 53 are generally formed in a roof shape bent to be inclined to both sides in section thereof. The magnetic cores 51a, 52a, and 53a are bent to the left and right along a surface shape of the heat roller 22 from the centers of the center coil 51 and the first and second side coils 52 and 53 respectively. A bending angle of the magnetic cores 51a, 52a, and 53a is set to, for example, 100° in an inner angle respectively.

A shape of the magnetic cores is not limited. For example, the sections of the magnetic cores may be formed in an arcuate shape parallel to the surface of the heat roller 22 to extend along the surface of the heat roller 22. Moreover, magnetism shielding sections may be protrudingly provided on both sides of the magnetic cores. It is possible to further improve concentration of magnetic fluxes on the heat roller 22 with the protrudingly-provided magnetism shielding sections.

As shown in FIG. 3, the center coil 51 has the length of, for example, 200 mm and heats the center area of the heat roller 22. The first and second side coils 52 and 53 are arranged on both sides of the center coil 51 respectively. The first and second side coils 52 and 53 are connected in series and driven by the same control. The entire length of the heat roller 22, for example, the length of 320 mm is heated by the center coil 51 and the first and second side coils 52 and 53. Outputs of the center coil 51 and the side coils 52 and 53 are alternately switched. The outputs of the center coil 51 and the side coils 52 and 53 may be simultaneous.

The center coil 51 and the first and second side coils 52 and 53 generate a magnetic flux respectively when a high-frequency current is applied thereto. An eddy current as an induction current is generated in the metal conductive layer 22c by this magnetic flux to prevent a change in a magnetic field. Joule heat is generated by this eddy current and the resistance of the metal conductive layer 22c. The heat roller 22 is heated by the Joule heat.

As the center coil 51 and the first and second side coils 52 and 53, a Litz wire as a conductive wire formed by, for example, binding plural copper wires having a diameter of about 0.1 mm to 0.5 mm, on a surface of which heat resistant enamel coating of, for example, heat resistant polyamideimide is applied, is used. Wires and insulating materials are not limited to the above and a wire diameter is arbitrary. When the Litz wire is used, the structure thereof is also arbitrary. The Litz wire may be formed by twisting plural insulated copper wires. The number and the thickness of the copper wires are not limited. The center coil 51 and the first and second side coils 52 and 53 are formed by winding the Litz wire around the magnetic cores 51a, 52a, and 53a plural times.

A temperature rise due to a copper loss of the Litz wire is caused in the center coil 51 and the first and second side coils 52 and 53 by the application of the high-frequency current. When the coil unit 27 is heated by this copper loss, coil performance is deteriorated. To prevent the deterioration in the coil performance, first and second fans 56 and 57 for cooling the coil unit 27 are provided on both sides of the coil unit 27 respectively.

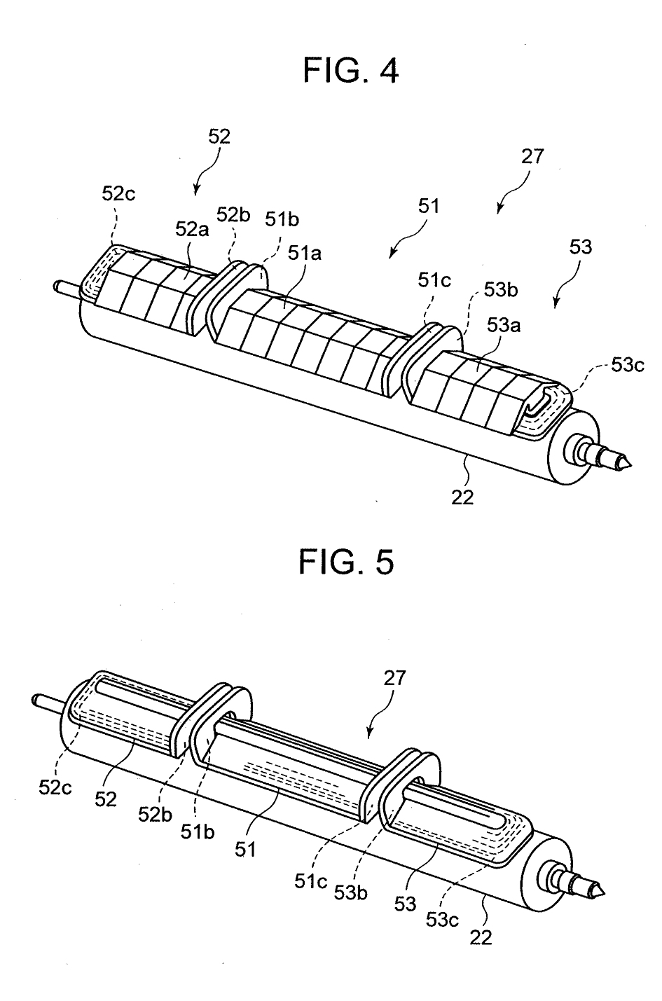

As shown in FIGS. 4 and 5, in the center coil 51, after the Litz wire is wound around the magnetic core 51a, both ends 51b and 51c on a side parallel to a rotating direction of the heat roller 22 are bent. In the center coil 51, when the Litz wire is wound around the magnetic core 51a, both the ends 51b and 51c may be formed while the Litz wire are sequentially piled up. Consequently, at both the ends 51b and 51c of the center coil 51, the Litz wire is wound to overlap in a direction away from the heat roller 22.

On the other hand, in the first and second side coils 52 and 53, after the Litz wire is wound around the magnetic cores 52a and 53a, only one sides 52b and 53b on the side parallel to the rotating direction of the heat roller 22 are bent respectively. In the side coils 52 and 53, when the Litz wire is wound around the magnetic cores 52a and 53a, the one sides 52b and 53b may be formed while the Litz wire is sequentially piled up. Consequently, on the one sides 52b and 53b of the first and second side coils 52 and 53, the Litz wire is wound to overlap in the direction away from the heat roller 22. A method of piling up the Litz wire is not limited. On the other hand, on the other sides 52c and 53c on the side parallel to the rotating direction of the heat roller 22 of the side coils 52 and 53, the Litz wire is simply wound in a shape along the surface of the heat roller 22 without being bent respectively.

In the first and second side coils 52 and 53, the one sides 52b and 53b where the Litz wire is bent are arranged to be opposed to both the sides 51b and 51c of the center coil 51, respectively. Consequently, both the sides of the coil unit 27 are formed by the other ends 52c and 53c of the first and second side coils 52 and 53 and an air flow generated by the first and second fans 56 and 57 is not disturbed.

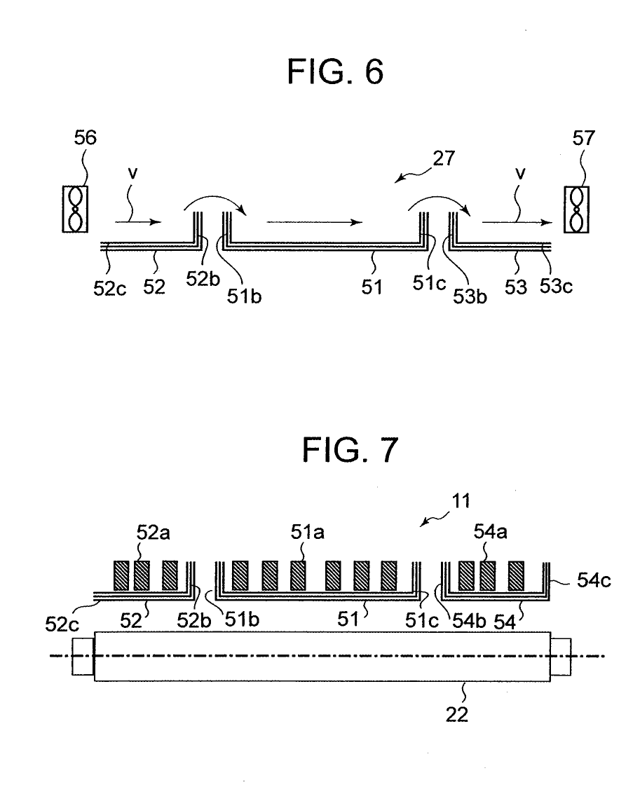

As shown in FIG. 6, an air flow in an arrow v direction generated by the first and second fans 56 and 57 is directly blown against the first side coil 52 and, then, blown against the center coil 51 getting over the one side 52b and the side 51b of the center coil 51. Moreover, the air flow in the v direction is blown against the center coil 51, then, blown against the second side coil 53 getting over the side 51c of the center coil 51 and the side 53b of the second side coil 53, and, thereafter, directly discharged by the second fan 57.

Since the Litz wire is bent on the one sides 52b and 53b of the first and second side coils 52 and 53 in this way, the width of joints (α) and (β) adjacent to the center coil 51 can be reduced. Consequently, a temperature fall in the heat roller 22 caused by the joints (α) and (β) of the center coil 51 and the first and second side coils 52 and 53 is prevented. On the other hand, since the Litz wire is simply wound on the other sides 52c and 53c of the first and second side coils 52 and 53, the flow of the air flow generated by the first and second fans 56 and 57 is improved.

Actions are described. According to the start of an image forming process, in the image forming unit 10, toner images are formed on the photoconductive drums 12Y, 12M, 12C, and 12K in the image forming stations 18Y, 18M, 18C, and 18K for the colors of yellow (Y), magenta (M), cyan (C), and black (K), respectively. The toner images on the photoconductive drums 12Y, 12M, 12C, and 12K are transferred respectively onto the sheet paper P on the transfer belt 10a, which is rotated in the arrow q direction, by the transfer rollers 15Y, 15M, 15C, and 15K to form a full color toner image on the sheet paper P.

According to the start of the image forming process, in the fixing device 11, the heat roller 22 is driven in the arrow s direction by the driving motor 25. The press roller 23 that follows the heat roller 22 is rotated in the arrow t direction. In the fixing device 11, the first and second fans 56 and 57 are driven and an air flow in the arrow v direction is generated in the coil unit 27. Moreover, in the fixing device 11, a high-frequency current is applied to the center coil 51 or the first and second side coils 52 and 53 according to a detection result of the surface temperature of the heat roller.22 by the first and second thermistors 33.

For example, if a size of the sheet paper P is a full size such as the A4 landscape size (297×210 mm) or the A3 size (297×420 mm) of the JIS standard, the fixing device 11 supplies electric power to the center coil 51 and the first and second side coils 52 and 53 to heat the entire length in the longitudinal direction of the heat roller 22. If a size of the sheet paper P is a small size such as the A4 portrait size (210×297 mm) or a postcard size (100×148 mm) of the JIS standard, the fixing device 11 supplies electric power only to the center coil 51 to heat the center of the heat roller 22. The sheet paper P having the full color toner image is passed through the nip 26 between the heat roller 22 heated in this way and the press roller 23 to heat, press, and fix the toner image and complete a print image.

According to the first embodiment, the width of the joints α and β of the center coil 51 and the first and second side coils 52 and 53 is reduced. Therefore, when the entire length of the heat roller 22 is heated, a temperature fall in the heat roller 22 caused by the width of the joints α and β of the coil unit 27 can be reduced. As a result, more uniform fixing temperature can be obtained over the entire length of the heat roller 22.

According to the first embodiment, on the other sides 52c and 53c of the first and second side coils 52 and 53, the Litz wire is simply wound without being bent. In other words, when the Litz wire is wound plural times to form the first and second side coils 52 and 53, after the Litz wire is simply wound plural times, only the one sides 52b and 53b has to be bent. As a result, compared with the time when both the sides are bent, a manufacturing process for the first and second side coils 52 and 53 can be simplified and a reduction in price of the coil unit 27 can be realized through a reduction in manufacturing cost.

Moreover, on the other sides 52c and 53c of the first and second side coils 52 and 53, the Litz coil is simply wound. Therefore, while fixing operation is performed, an air flow generated by the first-and second fans 56 and 57 is not disturbed by the other sides 52c and 53c of the first and second side coils 52 and 53. As a result, the cooling of the first and second side coils 52 and 53 are facilitated and coil performance of the first and second side coils 52 and 53 can be improved.

A second embodiment of the present invention is explained. The second embodiment is different from the first embodiment in a shape of a second side coil. Otherwise, the second embodiment is the same as the first embodiment. Therefore, in the second embodiment, components same as those explained in the first embodiment are denoted by the same reference numerals and signs and detailed explanation of the components is omitted.

In the second embodiment, as shown in FIG. 7, the first side coil 52 and a third side coil 54 are arranged on both the sides of the center coil 51 that configures a coil unit 61. The first and third side coils 52 and 54 are connected in series and driven by the same control. In the first side coil 52, on the one side 52b, the Litz wire is wound to overlap in a direction away from the heat roller 22. On the other side 52c, the Litz wire is simply wound. On the other hand, in the third side coil 54, as in the center coil 51, the Litz wire is wound around a magnetic core 54a plural times and both sides 54b and 54c are bent.

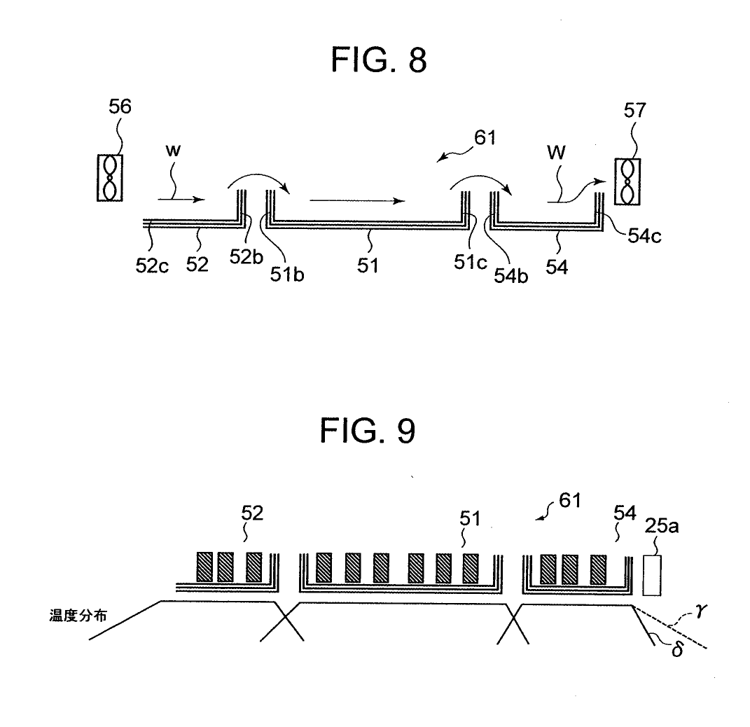

Therefore, as shown in FIG. 8, an air flow in an arrow w direction generated by the first and second fans 56 and 57 is directly blown against the first side coil 52 and, then, blown against the center coil 51 getting over the one side 52b and the side 51b of the center coil 51. Moreover, the air flow in the w direction is blown against the center coil 51 and, then, blown against the third side coil 54 getting over the side 51c of the center coil 51 and the side 54b of the third coil 54. However, thereafter, the air flow in the w direction is discharged by the second fan 57 getting over the side 54c of the third side coil 54.

A temperature distribution of the heat roller 22 heated by the metal conductive layer 22, which is caused to generate heat by the coil unit 60, and around the heat roller 22 is as shown in FIG. 9. On a side opposed to the first side coil 52 around which the Litz wire is simply wound on the other side 52c, the spread of a temperature distribution generated on an outer side of the heat roller 22 is large because of the influence of the other side 52c. On the other hand, on a side opposed to the third side coil 54 around which the Litz wire is piled up and wound on both the sides 54b and 54c, the influence of the side 54c is small. Consequently, on the side opposed to the third side coil 54, the spread of the temperature distribution generated on the outer side of the heat roller 22 is small.

On the side opposed to the third side coil 54, if the Litz wire is simply wound on the side 54c, the spread of the temperature distribution generated on the outer side of the heat roller 22 is as indicated by a dotted line γ. On the other hand, as in this embodiment, if the Litz wire is wound to overlap on the side 54c, the spread of the temperature distribution generated on the outer side of the heat roller 22 is as indicated by a solid line 6.

Therefore, for example, the driving motor 25 for the heat roller 22 or a driving unit 25a as a driving mechanism such as a link mechanism for the heat roller 22 is arranged on the third side coil 54 side as shown in FIG. 9. If the driving unit 25a is arranged on the third side coil 54 side, the spread of the temperature distribution generated on the outer side of the heat roller 22 is small. Therefore, even if the driving unit 25a is arranged close to the heat roller 22, it is unlikely that the driving unit 25a is affected by temperature. Therefore, since the driving unit 25a can be arranged closer to the heat roller 22, a reduction in size of the fixing device 11 can be realized.

According to the second embodiment, since the width of the joints of the center coil 51 and the first and third side cols 52 and 54 is reduced, more uniform fixing temperature is obtained over the entire length of the heat roller 22. Moreover, in the first side coil 52, only the Litz wire on the one side 52b has to be bent. Therefore, a manufacturing process for the first side coil 52 can be simplified and a reduction in price of the coil unit 60 is realized through a reduction in manufacturing cost.

Since the Litz wire is simply wound on the other side 52c of the first side coil 52, when fixing operation is performed, an air flow generated by the first and second fans 56 and 57 is not disturbed by the other side 52c of the first side coil 52. As a result, cooling of the first side coil 52 is facilitated. On the other hand, the Litz wire is bent on both the sides 54b and 54c of the third side coil 54. Therefore, the spread of the temperature distribution generated on the outer side of the heat roller 22 is small on the third side coil 54 side. Therefore, on the third side coil 54 side, the driving unit 25a for the heat roller 22 can be arranged closer to the heat roller 22 and a reduction in size of the fixing device can be realized.

The present invention is not limited to the embodiments described above. Various modifications are possible within the scope of the present invention. For example, the endless heating member may be a fixing belt and the number of times of winding of the conductive wire of the induction current generating coil is not limited. The induction current generating coil may be a single induction current generating coil rather than being divided into plural coils. In such a single induction current generating coil, if an air flow is generated from a side where the conductive wire is simply wound without being bent or piled up, since the air flow is directly blown against the induction current generating coil, cooling of the induction current generating coil can be facilitated. On the other hand, if the driving mechanism is arranged on a side where the conductive wire is bent, since the driving mechanism can be arranged closer to the heating member, a reduction in size of the induction heating fixing device can be realized.

What is claimed is:

1. An induction heating device comprising:
a conductive heat generating member of an endless shape; and
a first induction current generating coil formed by winding a conductive wire plural times to generate an induction current in the conductive heat generating member, wherein
in the first induction current generating coil, at one end in a direction parallel to a rotating direction of the conductive heat generating member, the conductive wire is wound along the shape of the conductive heat generating member and, at the other end in the direction parallel to the rotating direction of the conductive heat generating member, the conductive wire is wound to overlap in a direction away from the conductive heat generating member.

2. The device according to claim 1, further comprising a second induction current generating coil in which an induction current generating area of the conductive heat generating member in a rotating shaft direction of the conductive heat generating member is different from an induction current generating area formed by the first induction current generating coil.

3. The device according to claim 2, wherein, in the first induction current generating coil, the other end where the conductive wire is wound to overlap in a direction away from the conductive heat generating member is arranged to be adjacent to the second induction current generating coil.

4. The device according to claim 2, wherein the first induction current generating coil is arranged on both side of the second induction current generating coil, and the other end where the conductive wire is wound to overlap in a direction away from the conductive heat generating member is arranged to be adjacent to the second induction current generating coil.

5. The device according to claim 1, wherein a plurality of the first induction current generating coils are arranged in a rotating shaft direction of the conductive heat generating member.

6. The device according to claim 5, wherein, in the first induction current generating coil, the one end where the conductive wire is wound along the shape of the conductive heat generating member is arranged to be opposed to an end side of the conductive heat generating member.

7. A fixing device comprising:
a heating member that has a conductive heat generating member of an endless shape;
a first induction current generating coil formed by winding a conductive wire plural times to generate an induction current in the conductive heat generating member; and
a carrying member that nips and carries an image fixing medium in a predetermined direction together with the heating member, wherein
in the first induction current generating coil, at one end in a direction parallel to a rotating direction of the conductive heat generating member, the conductive wire is wound along the shape of the conductive heat generating member and, at the other end in the direction parallel to the rotating direction of the conductive heat generating member, the conductive wire is wound to overlap in a direction away from the conductive heat generating member.

8. The device according to claim 7, further comprising a second induction current generating coil in which an induction current generating area of the conductive heat generating member in a rotating shaft direction of the conductive heat generating member is different from an induction current generating area formed by the first induction current generating coil.

9. The device according to claim 8, wherein, in the first induction current generating coil, the other end where the conductive wire is wound to overlap in a direction away from the conductive heat generating member is arranged to be adjacent to the second induction current generating coil.

10. The device according to claim 8, wherein the first induction current generating coil is arranged on both side of the second induction current generating coil, and the other end where the conductive wire is wound to overlap in a direction away from the conductive heat generating member is arranged to be adjacent to the second induction current generating coil.

11. The device according to claim 8, wherein, in the rotating shaft direction of the conductive heat generating member, the second induction current generating coil is arranged at an end where a driving mechanism is provided and the first induction current generating coil is arranged at an end where the driving mechanism is not provided.

12. The device according to claim 7, wherein a plurality of the first induction current generating coils are arranged in a rotating shaft direction of the conductive heat generating member.

13. The device according to claim 12, wherein, in the first induction current generating coil, the one end where the conductive wire is wound along the shape of the conductive heat generating member is arranged to be opposed to an end side of the conductive heat generating member.

14. An image forming apparatus comprising:
an image forming unit that forms a toner image on an image carrier;
a heating member that has a conductive heat generating member of an endless shape and heats the toner image formed on an image fixing medium;
a first induction current generating coil formed by winding a conductive wire plural times to generate an induction current in the conductive heat generating member; and
a carrying member that nips and carries the image fixing medium in a predetermined direction together with the heating member, wherein
in the first induction current generating coil, at one end in a direction parallel to a rotating direction of the conductive heat generating member, the conductive wire is wound along the shape of the conductive heat generating member and, at the other end in the direction parallel to the rotating direction of the conductive heat generating member, the conductive wire is wound to overlap in a direction away from the conductive heat generating member.

15. The apparatus according to claim 14, further comprising a second induction current generating coil in which an induction current generating area of the conductive heat generating member in a rotating shaft direction of the conductive heat generating member is different from induction current generating area formed by the first induction current generating coil.

16. The apparatus according to claim 15, wherein, in the first induction current generating coil, the other end where the conductive wire is wound to overlap in a direction away from the conductive heat generating member is arranged to be adjacent to the second induction current generating coil.

17. The apparatus according to claim 15, wherein the first induction current generating coil is arranged on both side of the second induction current generating coil, and the other end where the conductive wire is wound to overlap in a direction away from the conductive heat generating member is arranged to be adjacent to the second induction current generating coil.

18. The apparatus according to claim 15, wherein, in the rotating shaft direction of the conductive heat generating member, the second induction current generating coil is arranged at an end where a driving mechanism is provided and the first induction current generating coil is arranged at an end where the driving mechanism is not provided.

19. The apparatus according to claim 14, wherein a plurality of the first induction current generating coils are arranged in a rotating shaft direction of the conductive heat generating member.

20. The apparatus according to claim 19, wherein, in the first induction current generating coil, the one end where the conductive wire is wound along the shape of the conductive heat generating member is arranged to be opposed to an end side of the conductive heat generating member.
